(19) United States
(12) Patent Application Publication
(10) Pub. No.: US 2026/0300982 A1
(43) Pub. Date: Oct. 1, 2026

(54) GENERATING FRAUD DETECTION RULES USING A TRAINED MODEL

(71) Applicant: MASTERCARD INTERNATIONAL INCORPORATED, PURCHASE, NY (US)

(72) Inventors: Anukriti SINGH, Kota (IN); Bhavy GANDHI, Banswara (IN)

(21) Appl. No.: 19/096,526

(22) Filed: Mar. 31, 2025

(51) Int. Cl. G06Q 20/40

(52) U.S. Cl. CPC G06Q 20/4016; G06Q 20/405

(57) ABSTRACT

A computerized method generates fraud detection rules using a trained decision tree model. Training transaction data is obtained and used to assemble a feature vector. A decision tree model is generated using the assembled feature vector and the generated decision tree model is trained using the obtained transaction data and a fraud indicator. A fraud detection rule is generated using the trained decision tree model. The generated fraud detection rule is applied to input transaction data and a transaction associated with fraud is identified in the input transaction data. A fraud mitigation action is performed in response to identifying the transaction associated with fraud. By training and using a model to generate the fraud detection rules, accurate rules can be efficiently generated with reduced manual effort.

### BACKGROUND

Fraud detection is a vital task in modern transaction processing systems. In many systems, fraud detection rules are used to evaluate transaction data to detect fraudulent behavior, but creating accurate rules is time consuming and requires significant manual effort. For instance, some fraud detection rules are determined by manually combining large quantities of data features to find combinations that meet the desired rule quality criteria.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for generating fraud detection rules is described. Training transaction data is obtained and used to assemble a feature vector. A decision tree model is generated using the assembled feature vector and the generated decision tree model is trained using the obtained transaction data and a fraud indicator. A fraud detection rule is generated using the trained decision tree model. The generated fraud detection rule is applied to input transaction data and a transaction associated with fraud is identified in the input transaction data. A fraud mitigation action is performed in response to identifying the transaction associated with fraud.

### BRIEF DESCRIPTION OF THE DRAWINGS

The present description will be better understood from the following detailed description read considering the accompanying drawings, wherein:

FIG. 1 is a block diagram illustrating an example system configured to generate and use fraud detection rules;

FIG. 2 is a flowchart illustrating an example method for detecting that a transaction is associated with fraud and performing fraud mitigation actions in response to that detection;

FIG. 3 is a flowchart illustrating a method for pruning a decision tree model for use in generating fraud detection rules;

FIG. 4 is a flowchart illustrating a method for combining fraud detection rules; and

FIG. 5 illustrates an example computing apparatus as a functional block diagram.

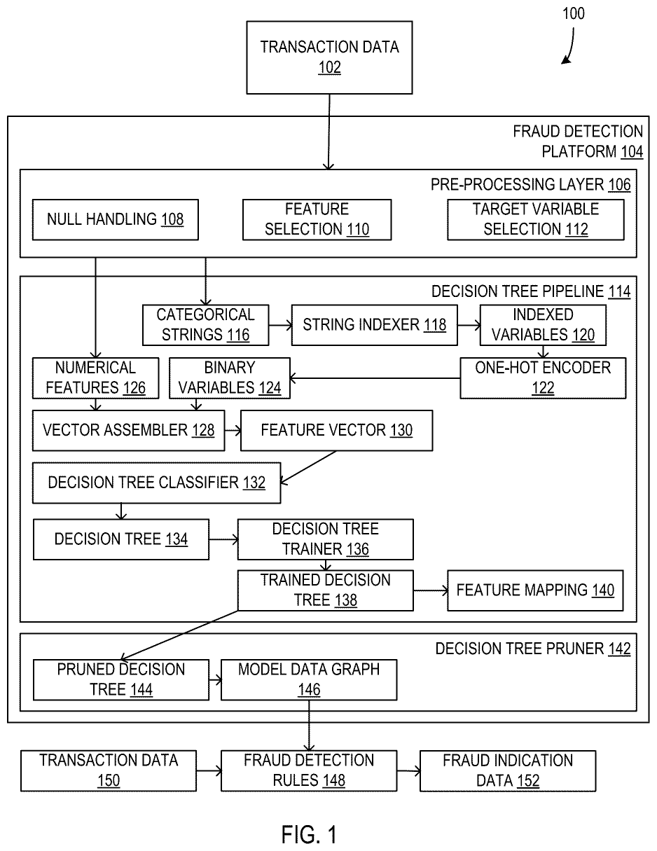

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

Aspects of the disclosure provide systems and methods for generating fraud detection rules using a trained decision tree model. Historical transaction data is obtained, and a decision tree model is generated and trained based on that historical transaction data. The training of the model includes pre-processing of the transaction data, configuring a target fraud indicator in association with the transaction data, and generating a feature vector based on selected features from the transaction data. The decision tree model is trained to accurately classify transaction data entries as either fraudulent or non-fraudulent in an efficient manner. Then, the structure of the trained decision tree model is used to generate fraud detection rules. In some examples, the decision tree model is pruned to enable the generation of broader, more efficient rules. Further, the generated fraud detection rules are analyzed to enable the combination of and/or streamlining of the set of fraud detection rules. Additionally, once the fraud detection rules are in use, the performance and stability of the rules are monitored and rules that do not perform with sufficient accuracy or stability can be taken out of use and new rules can rapidly be generated.

The disclosure operates in an unconventional manner at least by using the trained thresholds and other values of the decision tree model to generate the conditions of the fraud detection rules. In some other systems, the conditions of fraud detection rules are selected manually using essentially trial and error, wherein many conditions are combined into many combinations which are then evaluated against historical transaction data for performance. Aspects of the disclosure enable the automatic generation of fraud detection rules with finely tuned conditions, substantially reducing the time and manual effort spent on rule generation. Further, the rules generated using the disclosed systems and methods are likely to be more optimally accurate than manually created rules due to the effect of training the decision tree model to accurately classify transactions and then using the values of the decision tree model for automatic generation of the rules. The reduced cost in time and resources provided by the disclosed systems and methods are multiplied for each time that the fraud detection rules need to be regenerated due to changes in performance and stability. Thus, the disclosed systems and methods provide a specific improvement over prior systems and methods for fraud detection rule generation, resulting in improved efficiency and accuracy, and reduced costs, when generating fraud detection rules.

Additionally, aspects of the invention enable improved efficiency in applying generated fraud detection rules to transaction data in real-time or near real-time. In some examples, the disclosed systems and methods automatically prune the decision tree structure prior to rule generation in order to preserve the nodes that provide effective classification of large quantities of the transaction data while reducing the overall depth and complexity of the decision tree. Then, when rules are generated based on the pruned decision tree, there are fewer generated rules to be applied and those rules that are generated are sharply focused on the accurate classification of relatively large portions of incoming transaction data. Highly granular rules are avoided in order to reduce the total quantity of rules that must be applied in real-time while maintaining the overall accuracy of the set of fraud detection rules.

FIG. 1 is a block diagram illustrating an example system 100 configured to generate and use fraud detection rules 148. In some examples, the fraud detection platform 104 of the system 100 obtains transaction data 102 and/or other associated data and pre-processes the obtained data in the pre-processing layer 106. During pre-processing, null handling 108, feature selection 110, and target variable selection 112 are performed. Pre-processed data is provided to the decision tree pipeline 114, which is configured to generate a trained decision tree 138 and an associated feature mapping 140. The trained decision tree 138 is then pruned using the decision tree pruner 142 and the resulting pruned decision tree 144 is used to generate the fraud detection rules 148. The fraud detection rules 148 are then applied to transaction data 150 in order to generate fraud indication data 152 that include indications as to which transactions in the transaction data 150 are fraudulent or otherwise associated with detected fraud events.

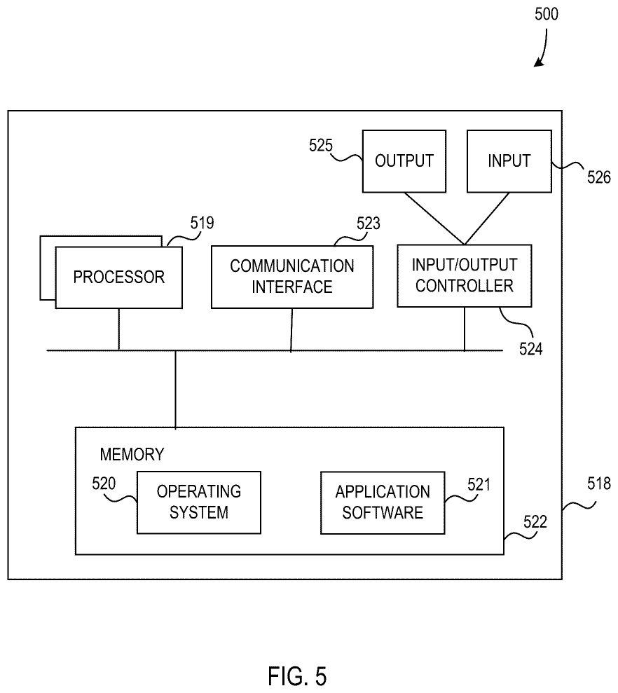

Further, in some examples, the system 100 includes one or more computing devices (e.g., the computing apparatus of FIG. 5) that are configured to communicate with each other via one or more communication networks (e.g., an intranet, the Internet, a cellular network, other wireless network, other wired network, or the like). In some examples, entities of the system 100 are configured to be distributed between the multiple computing devices and to communicate with each other via network connections. For example, the pre-processing layer 106 is executed on a first computing device and the decision tree pipeline 114 is located on a second computing device within the system 100. The first computing device and second computing device are configured to communicate with each other via network connections. Alternatively, in some examples, other components of the decision tree pipeline 114 (e.g., the vector assembler 128 and the decision tree classifier 132) are executed on separate computing devices and those separate computing devices are configured to communicate with each other via network connections during the operation of the decision tree pipeline 114. In other examples, other organizations of computing devices are used to implement system 100 without departing from the description.

In some examples, upon receiving the transaction data 102, the pre-processing layer 106 performs null handling 108. Null handling includes identifying rows in the transaction data 102 that are empty or otherwise missing a defined number of values (e.g., if 50% of a row is missing values, the row is considered “empty”). After identifying such empty rows, those empty rows are removed from the transaction data 102. Alternatively, and/or additionally, in some examples, null handling 108 includes filling in some missing data values of rows to reduce the quantity of rows that are empty. Filling in values may include filling empty places in rows with known default values, “other” values, and/or mean/average values. It should be understood that this value-filling process is used only in ways that do not affect the capacity of the rows to be analyzed as to whether the associated transactions are fraudulent.

Further, in some examples, the pre-processing layer 106 performs feature selection 110 in association with the obtained transaction data 102. Feature selection 110 includes analyzing features and/or columns in the transaction data that may be used in the generation of and/or training of the trained decision tree 138. The features selected during feature selection 110 include those features that are the most important features for enabling the decision tree 138 to perform efficiently and accurately at detecting fraud. For instance, in some examples, features selected during feature selection 110 are those features that best separate the target classes, which are transactions associated with fraud activity and transactions not associated with fraud activity. In some such examples, feature selection 110 includes processes such as recursive feature elimination, mutual information, and/or statistical tests that are applied to further refine the feature set before the training process.

In some examples, the pre-processing layer 106 performs target variable selection 112. In many of the examples described herein, the target variable is a variable that is indicative of fraud, or a fraud indicator. In other examples, other target variables are used to train the trained decision tree 138 for other purposes without departing from the description.

The pre-processing layer 106 provides data to the decision tree pipeline 114, such as the categorical strings 116 and the numerical features 126, in addition to any data from the transaction data 102 that is used by the decision tree pipeline 114. In some examples, categorical indicators (e.g., the identifiers of columns in the database) are stored as strings rather than codes or numbers. The generation and training of the trained decision tree 138 is more effective if all of the features are in numerical form, so the categorical strings 116 are converted by a string indexer 118 into indexed variables 120, which are in a numeric format. Further, the indexed variables 120 are transformed by a one-hot encoder 122 into binary variables 124 that are used by the vector assembler 128.

Further, in some examples, the vector assembler 128 uses the one-hot encoded binary variables 124 and the numerical features 126 to generate a feature vector 130. The feature vector 130 is in a format that is required for the generation of the decision tree 134. Additionally, the data in the feature vector 130 is standardized in a way that improves the efficiency and compatibility with machine learning (ML) algorithms, such as the ML algorithm used to create and train the trained decision tree 138.

In some examples, the feature vector 130 is used by the decision tree classifier 132 to generate the decision tree 134. The decision tree classifier 132 is configured to specify the input features and target label columns of the decision tree 134. After the decision tree classifier 132 initializes the decision tree 134, the decision tree trainer 136 is configured to train the decision tree 134 into the trained decision tree 138.

The decision tree trainer 136 is configured to generate branches and nodes of the decision tree 134 by splitting the input data according to the provided features. For instance, in some examples, splitting criteria such as Gini impurity or information gain are used to cause maximum class separation between transactions associated with fraud and transactions not associated with fraud. The resulting trained decision tree 138 includes a plurality of nodes, each representing a decision rule about the class of an input data entry, and branches between the nodes. Leaf nodes (e.g., nodes that do not have any children that branch from them) represent the assignment of a class label to the input data entry when the evaluation by the trained decision tree 138 reaches that leaf. After the training of the trained decision tree 138 is complete, the trained decision tree 138 is configured to classify input data entries as either transactions associated with fraud or transactions not associated with fraud.

Additionally, in some examples, the decision tree pipeline 114 is configured to generate a trained decision tree 138 with limits, such as a maximum depth of the tree (e.g., a maximum of 20 branches from the root node). Such a limitation reduces the occurrence of splitting that is too granular and reduces the likelihood of overfitting by the trained decision tree 138.

In some examples, the trained decision tree 138 is saved and used to generate a feature mapping 140. The feature mapping 140 is a mapping between the indexed feature indices used in the model and the original feature names from the transaction data 102. This feature mapping 140 is used in later steps to enable an understanding of how the trained decision tree 138 has interpreted the input features.

After the trained decision tree 138 is completed, it is provided to the decision tree pruner 142 where it is transformed into a pruned decision tree 144. Pruning reduces the size of the decision tree 138 by removing parts of the tree that do not substantially contribute to the classification of input data entries. In some examples, the nodes and branches are evaluated based on the Transaction False Positive Rate (TFPR), or the ratio of non-fraud transactions to fraud transactions as identified by the nodes or branches. For instance, paths of the decision tree are backtracked and if a node reaches a TFPR threshold of 3:1, the node is prevented from splitting further. The result is simpler, higher impact rules. In other examples, metrics other than TFPR are used instead of or in conjunction with TFPR without departing from the description.

Additionally, or alternatively, in some examples, data of the trained decision tree 138 is interpreted with respect to the parent and grandparent of each node to better understand the decision being made at the node. A pruning mechanism based on impurity statistics is applied. For instance, in some examples, the impurity ratio of num_one (e.g., the quantity of entries that are classified as fraudulent) to num_zero (e.g., the quantity of entries classified as not fraudulent) for a node is calculated and, if the ratio is found to be greater than or equal to .33, it suggest that the node is quite certain about one class over the other. High certainty can indicate that the model might be too confident in this decision path, potentially leading to overfitting.

Further, in some examples, the grandparent of the node being analyzed for pruning is checked to confirm that the grandparent is valid, which is crucial for maintaining the structure of the tree.

In some such examples, if the impurity ratio of a node is greater than or equal to 0.33 (or some other defined threshold) and the node has a valid grandparent node, the child nodes of the node being analyzed are removed. As a result, input data entries that reach the node are then classified by the node based on the rule that the node represents.

When the pruned decision tree 144 is complete, a model data graph 146 is generated from the pruned decision tree 144. In some examples, generating the model data graph 146 includes backtracking the path created by the pruned decision tree 144. The model data graph 146 is then used to create fraud detection rules 148. In some such examples, each fraud detection rule 148 is generated by starting with a leaf node or pruned node of the pruned decision tree 144 and tracing its path to the root node. At each node, rule filters associated with the node are added to the fraud detection rule 148 that is being generated. Additionally, in some such examples, each generated fraud detection rule 148 satisfies these criteria: the rule has a TFPR threshold of 3 or less, the minimum number of frauds the rule captures is at least 40, and the node with which the rule is associated is leaf node or a pruned node of the pruned decision tree 144.

Additionally, or alternatively, in some examples, a fraud detection rule 148 is subjected to a quality check. For instance, in an example, a rule is checked to confirm that it covers at least 10 distinct card numbers, account numbers, or the like. Further, a rule is checked to confirm that it is stable month after month. This means that the criteria described above are true for most of the time (e.g., 66% of the time). Thus, if a rule is created with data from six months of time, the criteria for the rule are satisfied for at least four of the six months (e.g., the TFPR of the rule is 3 or less for four months of the total six months).

Further, in some examples, generating the fraud detection rules 148 includes performing rule optimization processes. In most cases, the pruned decision tree 144 decides how to classify an input data entry based on only one feature at each node. However, fraud detection rules 148 be designed to involve more than one feature in a single decision. Thus, features in a fraud detection rule 148 that is generated from the pruned decision tree 144 can sometimes be grouped for efficiency. For instance, in an example, there are several branches of the pruned decision tree 144 that are based on the country in which the transaction takes place. One branch evaluates whether the transaction took place in Canada, and another evaluates whether the transaction took place in the USA. If both branches result in a valid fraud detection rule 148 based on the described criteria, then those two fraud detection rules 148 can be combined into one rule that evaluates whether the transaction took place in Canada or the USA. In other examples, other methods of optimizing the fraud detection rules 148 without departing from the description.

Additionally, or alternatively, in some examples, the fraud detection rules 148 are refined in other ways. For instance, features of the language in which the rules are written can be used to refine and/or optimize rules. If a rule is expressed in Structured Query Language (SQL) and the rule includes the text “mcc=‘5542’ and mcc=‘5567’ and mcc=‘6678’ and pan_ent_mode=‘21’ and pan_ent_mode=‘51’”, SQL features can be used to refine the rule text as “mcc in (‘5542,’5567’,‘6678’) and pan_ent_mode in (‘21’,‘51’)”. Other methods of rule refinement are used in other examples without departing from the description.

Further, in some examples, when generation of the fraud detection rules 148 is complete, they are used to evaluate transaction data 150 and generate fraud indication data 152, which indicates which transactions are associated with fraud and/or which transactions are not associated with fraud. Such fraud indication data 152 can then be used in fraud reporting and prevention tasks.

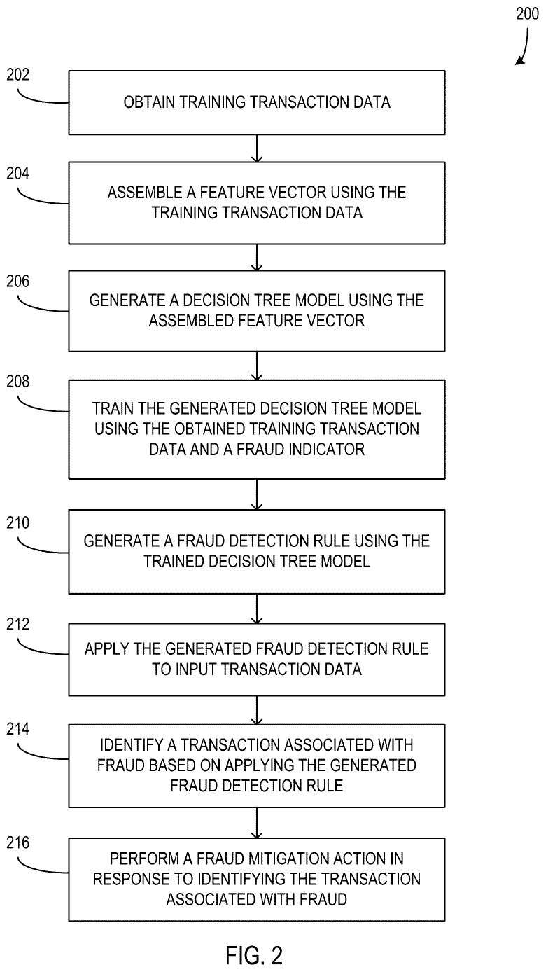

FIG. 2 is a flowchart illustrating an example method 200 for detecting that a transaction is associated with fraud and performing fraud mitigation actions in response to that detection. In some examples, the method 200 is executed or otherwise performed in association with a system such as system 100 of FIG. 1.

At 202, training transaction data is obtained. In some examples, the training transaction data is obtained from one or more issuers, acquirers, or other entities that are associated with processing transactions.

At 204, a feature vector is assembled using the training transaction data. In some examples, assembling the feature vector includes pre-processing the training transaction data (e.g., pre-processing transaction data 102 by pre-processing layer 106) and/or identifying and formatting features that are the most useful for the detection of fraud (e.g., the numerical features 126 and/or the binary variables 124 that have been generated based on the categorical strings 116 of the transaction data 102). In some such examples, the assembly of the feature vector also includes scaling or normalizing of feature values in the feature vector to prevent undesirable biases.

At 206, a decision tree model is generated using the assembled feature vector and then, at 208, the generated decision tree model is trained using the training transaction data and a fraud indicator. It should be understood that, for at least part of the training transaction data, it is known whether the associated transactions are associated with fraudulent activity and that the transactions are flagged with the fraud indicator that indicates whether an associated transaction is associated with fraud. The decision tree model is trained to accurately identify whether a given transaction should be flagged with a positive or negative fraud indicator and, as a result, the decision tree model is trained to identify whether a transaction is fraudulent or otherwise associated with fraudulent activity.

In some examples, the training of the decision tree model includes providing the decision tree model with some portion of the training transaction data as input, obtaining classification output from the decision tree model, and evaluating the classification output for accuracy. Depending on how accurate the classification output is and/or the way(s) that the decision tree model misclassified transactions in the input, aspects of the decision tree model are adjusted to improve its accuracy during future operation. In some such examples, the aspects that are adjusted include weight factors, decision thresholds of tree nodes (e.g., the value of a feature that causes a transaction to be classified as one class or another by a specific node), the tree structure (e.g., how the tree branches and/or how deep the tree grows), or the like. It should be understood that, in some examples, training the decision tree model includes other machine learning techniques without departing from the description. Additionally, while many examples herein describe the use of a decision tree model, in other examples, the systems and methods described herein use other types of classification models to classify transactions without departing from the description.

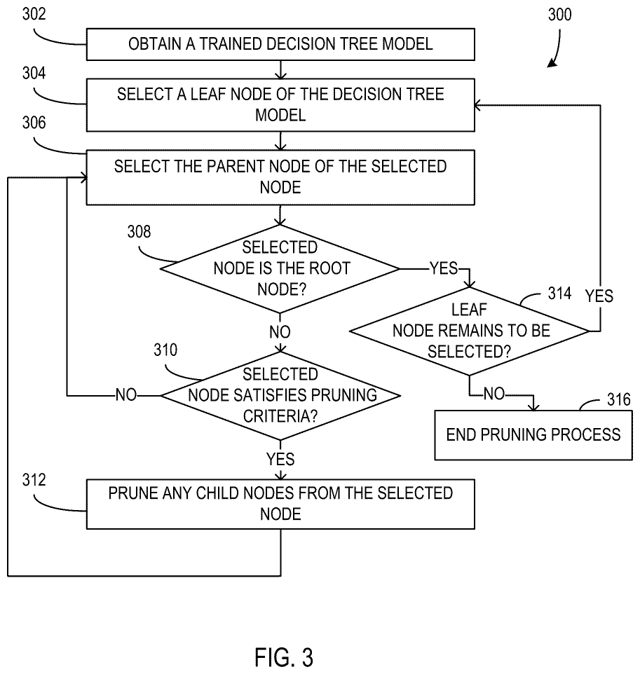

Additionally, or alternatively, in some examples, the trained decision tree model is pruned as described herein, such that the quantity of nodes in the tree is reduced to only those nodes that are sufficiently effective at classifying transaction data. The pruning process is described in greater detail below with respect to FIG. 3.

At 210, a fraud detection rule is generated using the trained decision tree model. In some examples, generating the fraud detection rule includes identifying a leaf node of the decision tree model and moving up the decision tree model node by node to the root node. At each node, a portion of the fraud detection rule is generated based on the decision threshold of the node. For instance, if a decision threshold of a node is that the transaction amount is less than $25, then the fraud detection rule with be generated to include that decision threshold being required to satisfy the fraud detection rule.

Further, in some examples, the generation of the fraud detection rule includes performing a quality check on the fraud detection rule before finalizing it. For instance, in an example, when the fraud detection rule is complete, it is confirmed that the rule covers at least 10 (or another number) distinct account values and that the rule is stable over time. If the rule satisfies these quality checks, it is then used in detecting fraud within transaction data. Alternatively, if the rule fails to satisfy the quality checks, it may be removed from the current sets of fraud detection rules or otherwise altered to satisfy the quality checks.

Additionally, in some examples, generation of the fraud detection rule includes generating a plurality of fraud detection rules from the decision tree model, each of which is then used to detect fraud in transaction data. Further, in some examples, after multiple fraud detection rules have been generated, some of the multiple fraud detection rules are combined into single rules, when possible, as described herein.

At 212, the generated fraud detection rule is applied to input transaction data and, at 214, a transaction associated with fraud is identified based on the application of the generated fraud detection rule. After the detection of the fraud-associated transaction, at 216, a fraud mitigation action is performed in response. In some examples, the fraud mitigation action includes blocking or freezing affected accounts, reversing or disputing transactions, sending notifications to entities involved with the transaction, monitoring associated accounts more closely for future fraud, generating fraud reports for use by transaction processing entities and/or law enforcement, or the like. In some such examples, the fraud mitigation action is automatically triggered upon the detection of the fraud, such that response to the detected fraud is rapid and able to reduce or minimize the negative effects of the fraudulent activities.

FIG. 3 is a flowchart illustrating a method 300 for pruning a decision tree model for use in generating fraud detection rules. In some examples, the method 300 is executed or otherwise performed in association with a system such as system 100 of FIG. 1. Further, in some examples, the method 300 is performed as part of a method such as method 200 of FIG. 2.

At 302, a trained decision tree model (e.g., the trained decision tree 138) is obtained. At 304, a leaf node of the decision tree model is selected and, at 306, the parent node of the selected node is selected.

If the selected node is not the root node of the decision tree model, the process proceeds to 310. Alternatively, if the selected node is the root node of the decision tree model, the process proceeds to 314.

At 310, If the selected node satisfies the pruning criteria, the process proceeds to 312. Alternatively, if the selected node does not satisfy the pruning criteria, the process returns to 306 to select the parent node of the selected node. In some examples, the pruning criteria include evaluating the node based on the TFPR, confirming that the node has a valid grandparent, or the like.

At 312, any child nodes of the selected node are pruned, or removed, from the trained decision tree model and the process returns to 306 to select the parent node of the selected node.

At 314, after it has been determined that the selected node is the root node, if leaf nodes remain to be selected, the process returns to 304 to select another leaf node that has not yet been selected. Alternatively, if there are no more leaf nodes to select, the process ends at 316.

As illustrated, the method 300 moves through the decision tree from each leaf node up to the root node and prunes child nodes along the way when it is determined that a selected node satisfies the pruning criteria. This reduces the number of steps required to classify transactions as being associated with fraud or not associated with fraud while keeping nodes that are effective at that classification.

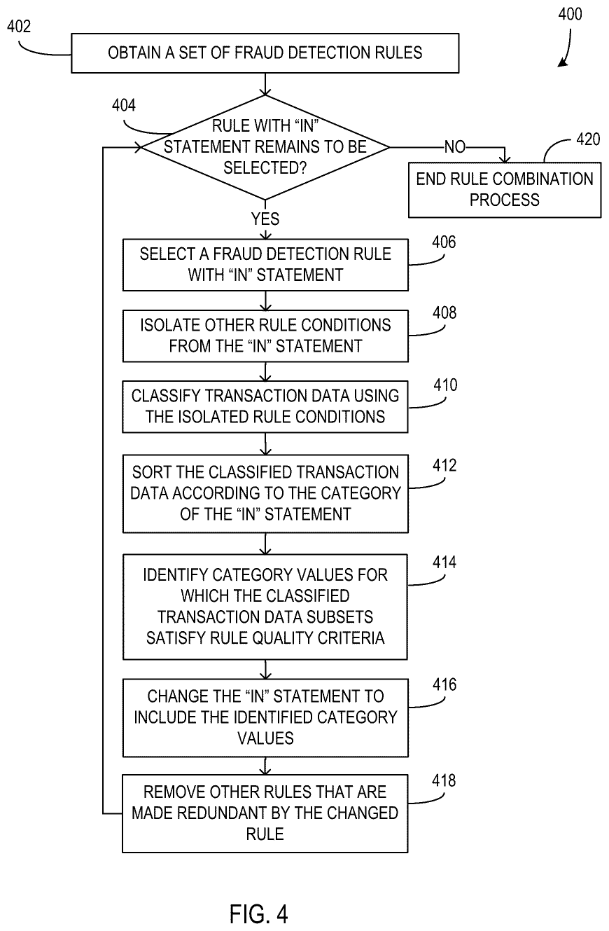

FIG. 4 is a flowchart illustrating a method 400 for combining fraud detection rules. In some examples, the method 400 is executed or performed in association with a system such as system 100 of FIG. 1. Additionally, in some examples, the method 400 is performed as part of a method such as method 200 of FIG. 2.

At 402, a set of fraud detection rules (e.g., fraud detection rules 148) is obtained. In some examples, the set of fraud detection rules is generated based on a trained decision tree model as described herein. Because nodes of the decision tree only evaluate transaction data based on a single decision, the rules resulting from the decision tree are sometimes fragmented in an inefficient way. The method 400 is performed to reduce the fragmentation of the fraud detection rules, thereby improving the efficiency with which they can be used to evaluate transaction data.

At 404, if a rule with an “in” statement remains to be selected, the process proceeds to 406. Alternatively, if no rule with an “in” statement remains to be selected, the process ends at 420. In some examples, an “in” statement is associated with a category by which transaction data entries can be categorized (e.g., the “in” refers to a particular data entry being in the category of the associated categorical value). For instance, in an example, transaction data entries include a country category that identifies the country in which the associated transaction took place, so a fraud detection rule may include an “in” statement that requires a transaction data entry to be “in” a specific country category (e.g., Canada or the USA) to satisfy the rule. Because the trained decision tree only evaluates for one country category value in a node, the set of rules that result sometimes include several rules that are evaluating country category values for different countries while otherwise being equivalent rules (e.g., a first rule checks for x value and that the transaction occurred in Canada while a second rule checks for the same x value and that the transaction occurred in the USA).

At 406, a fraud detection rule with an “in” statement is selected. In some examples, the selected fraud detection rule has not been selected before.

At 408, the other rule conditions of the selected rule are isolated from the “in” statement. For instance, in an example, the rule includes a first condition that the amount of the transaction exceeds $500 and a second condition that the Decline Insight Score (DI score) of the transaction exceeds 500. These two conditions are isolated from the “in” statement of the selected rule for use in the process.

At 410, transaction data, such as training transaction data 102, is classified using the isolated rule conditions and, at 412, the classified transaction data is sorted according to the category of the “in” statement. For instance, in an example, the two rule conditions described above are used to classify a group of transaction data entries and then those classified transaction data entries are sorted according to the country in which they occurred (e.g., transaction data entries occurring in Canada are grouped together and transaction data entries occurring in the United States of America (USA) are grouped together).

At 414, category values for which the classified transaction data subset satisfy rule quality criteria are identified. In the continuing example, each country-based group of classified transaction data entries are evaluated using the rule quality criteria, such as the TFPR criteria described herein. The countries of each group that satisfy the rule quality criteria are identified.

At 416, the “in” statement of the selected rule is changed to include the identified category values. For instance, in the continuing example, if three countries, Canada, USA, and Mexico, were all found to be associated with classified transaction data sets that satisfied the rule quality criteria, the “in” statement of the selected rule is changed from just evaluating for Canada to evaluating for Canada, USA, and Mexico. As a result, the new “in” statement of the selected fraud detection rule is satisfied when a transaction data entry is associated with any of Canada, USA, or Mexico.

At 418, other rules that are made redundant by the changed fraud detection rule are identified and removed. For instance, in the continuing example, if a rule exists with an “in” statement that checks for the USA and that has the same other conditions, the rule has been made redundant by the changed rule, effectively grouping this rule into the changed rule. So, the rule is removed from the fraud detection rules. Then, the process returns back to 404 to check if any rules with “in” statements remain to be selected.

It should be understood that, while this rule combination method is based on “in” statements, in other examples, other syntax is used in the fraud detection rules and those rules are combined using other rule combination methods without departing from the description.

### Exemplary Operating Environment

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the device. In some examples, generating fraud detection rules using a trained decision tree model as described herein is accomplished by software, hardware, and/or firmware.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUS).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: obtain training transaction data; assemble a feature vector using the training transaction data; generate a decision tree model using the assembled feature vector; train the generated decision tree model using at least a portion of the obtained training transaction data and a fraud indicator; generate a fraud detection rule using the trained decision tree model; apply the generated fraud detection rule to input transaction data; identify a transaction associated with fraud in the input transaction data based on applying the generated fraud detection rule; and perform a fraud mitigation action in response to identifying the transaction associated with fraud.

An example computerized method comprises obtaining training transaction data; assembling a feature vector using the training transaction data; generating a decision tree model using the assembled feature vector; training the generated decision tree model using at least a portion of the obtained training transaction data and a fraud indicator; generating a fraud detection rule using the trained decision tree model; applying the generated fraud detection rule to input transaction data; identifying a transaction associated with fraud in the input transaction data based on applying the generated fraud detection rule; and performing a fraud mitigation action in response to identifying the transaction associated with fraud.

One or more computer storage media having computer-executable instructions that, upon execution by a processor, case the processor to at least: obtain training transaction data; assemble a feature vector using the training transaction data; generate a decision tree model using the assembled feature vector; train the generated decision tree model using at least a portion of the obtained training transaction data and a fraud indicator; generate a fraud detection rule using the trained decision tree model; apply the generated fraud detection rule to input transaction data; identify a transaction associated with fraud in the input transaction data based on applying the generated fraud detection rule; and perform a fraud mitigation action in response to identifying the transaction associated with fraud.

Alternatively, or in addition to the other examples described herein, examples include any combination of the following:
further comprising pruning the trained decision tree model, the pruning comprising: identifying a node of the trained decision tree model; determining that an impurity ratio of the identified node exceeds an impurity ratio threshold; and pruning child nodes of the identified node based on determining that the impurity ratio of the identified node exceeds the impurity ratio threshold.
wherein pruning the trained decision tree model further includes: determining that the identified node has a valid grandparent node; and wherein pruning the child nodes of the identified node is further based on determining that the identified node has a valid grandparent node.
wherein assembling the feature vector using the training transaction data includes: generating data features and the fraud indicator using the obtained training transaction data; transforming categorical strings of the generated data features into binary variables; and assembling the feature vector using the generated data features and the binary variables.
wherein generating the data features using the obtained training transaction data includes identifying a data feature of the training transaction data that most accurately divides transactions of the training transaction data into a fraud class and a non-fraud class.
wherein generating a fraud detection rule using the trained decision tree model includes: generating a first initial fraud detection rule and a second initial fraud detection rule using the trained decision tree model; determining that conditions of the first initial fraud detection rule and conditions of the second initial fraud detection rule are combinable; and combining the first initial fraud detection rule and the second initial fraud detection rule into the generated fraud detection rule.
wherein performing a fraud mitigation action in response to identifying the transaction associated with fraud includes at least one of generating a fraud notification associated with the identified transaction, preventing completion of the identified transaction, or implementing fraud prevention measures associated with transactions that are similar to the identified transaction.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for obtaining training transaction data; an exemplary means for assembling a feature vector using the training transaction data; an exemplary means for generating a decision tree model using the assembled feature vector; an exemplary means for training the generated decision tree model using at least a portion of the obtained training transaction data and a fraud indicator; an exemplary means for generating a fraud detection rule using the trained decision tree model; an exemplary means for applying the generated fraud detection rule to input transaction data; an exemplary means for identifying a transaction associated with fraud in the input transaction data based on applying the generated fraud detection rule; and an exemplary means for performing a fraud mitigation action in response to identifying the transaction associated with fraud.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A system comprising:
a processor; and
a memory comprising computer program code, the memory and the computer program code configured to cause the processor to:
obtain training transaction data;
assemble a feature vector using the training transaction data;
generate a decision tree model using the assembled feature vector, the decision tree model including a plurality of nodes;
train the generated decision tree model by providing at least a portion of the training transaction data as input to the decision tree model, obtaining classification output from the decision tree model, evaluating the classification output for accuracy relative to a fraud indicator, and adjusting at least one of weight factors, decision thresholds of nodes of the decision tree model, or tree structure based on the evaluated accuracy;
determine that an impurity ratio of at least one node of the trained decision tree model exceeds an impurity ratio threshold;
based on the determination, eliminate overfitting by pruning one or more child nodes of the at least one node to create a pruned decision tree model;
generate a fraud detection rule using the pruned decision tree model by backtracking a path through the pruned decision tree model starting with a leaf node or pruned node and tracing the path to a root node, and, at each node along the path, generating at least a portion of the fraud detection rule based on a decision threshold of the node;
apply the generated fraud detection rule to input transaction data;
identify a transaction associated with fraud in the input transaction data based on applying the generated fraud detection rule; and
automatically perform a fraud mitigation action in response to identifying the transaction associated with fraud.

2. The system of claim 1, wherein the memory and the computer program code are configured to further cause the processor to prune the trained decision tree model, the pruning comprising:
identifying a node of the trained decision tree model;
determining that an impurity ratio of the identified node exceeds an impurity ratio threshold;
determining that the identified node has a valid grandparent node; and
pruning child nodes of the identified node based on determining that the impurity ratio of the identified node exceeds the impurity ratio threshold and determining that the identified node has the valid grandparent node.

3. The system of claim 1, wherein generating the fraud detection rule includes adding, to the fraud detection rule, a rule filter associated with one or more nodes of the pruned decision tree model.

4. The system of claim 1, wherein assembling the feature vector using the training transaction data includes:
generating data features and the fraud indicator using the obtained training transaction data; and
transforming categorical strings of the generated data features into binary variables; and
assembling the feature vector using the generated data features and the binary variables.

5. The system of claim 1, wherein training the generated decision tree model includes splitting input data according to one or more splitting criteria that cause maximum class separation between transactions associated with fraud and transactions not associated with fraud.

6. The system of claim 1, wherein generating a fraud detection rule using the trained decision tree model includes:
generating a first initial fraud detection rule and a second initial fraud detection rule using the trained decision tree model;
determining that conditions of the first initial fraud detection rule and conditions of the second initial fraud detection rule are combinable; and
combining the first initial fraud detection rule and the second initial fraud detection rule into the generated fraud detection rule.

7. The system of claim 1, wherein performing a fraud mitigation action in response to identifying the transaction associated with fraud includes at least one of generating a fraud notification associated with the identified transaction, preventing completion of the identified transaction, or implementing fraud prevention measures associated with transactions that are similar to the identified transaction.

8. A computerized method comprising:
obtaining training transaction data;
assembling a feature vector using the training transaction data;
generating a decision tree model using the assembled feature vector, the decision tree model including a plurality of nodes;
training the generated decision tree model by providing at least a portion of the training transaction data as input to the decision tree model, obtaining classification output from the decision tree model, evaluating the classification output for accuracy relative to a fraud indicator, and adjusting at least one of weight factors, decision thresholds of nodes of the decision tree model, or tree structure based on the evaluated accuracy;
determining that an impurity ratio of at least one node of the trained decision tree model exceeds an impurity ratio threshold;
based on the determination, eliminating overfitting by pruning one or more child nodes of the at least one node to create a pruned decision tree model;
generating a fraud detection rule using the pruned decision tree model by backtracking a path through the pruned decision tree model starting with a leaf node or pruned node and tracing the path to a root node, and, at each node along the path, generating at least a portion of the fraud detection rule based on a decision threshold of the node;
applying the generated fraud detection rule to input transaction data;
identifying a transaction associated with fraud in the input transaction data based on applying the generated fraud detection rule; and
automatically performing a fraud mitigation action in response to identifying the transaction associated with fraud.

9. The computerized method of claim 8, further comprising pruning the trained decision tree model, the pruning comprising:
identifying a node of the trained decision tree model;
determining that an impurity ratio of the identified node exceeds an impurity ratio threshold;
pruning child nodes of the identified node based on determining that the impurity ratio of the identified node exceeds the impurity ratio threshold; and
designating the identified node as a pruned node of the pruned decision tree model, wherein generating the fraud detection rule comprises backtracking a path through the pruned decision tree model starting with the pruned node.

10. The computerized method of claim 9, wherein pruning the trained decision tree model further includes:
determining that the identified node has a valid grandparent node; and
wherein pruning the child nodes of the identified node is further based on determining that the identified node has a valid grandparent node.

11. The computerized method of claim 8, wherein assembling the feature vector using the training transaction data includes:
generating data features and the fraud indicator using the obtained training transaction data; and
transforming categorical strings of the generated data features into binary variables; and
assembling the feature vector using the generated data features and the binary variables.

12. The computerized method of claim 11, wherein generating the data features using the obtained training transaction data includes identifying a data feature of the training transaction data that most accurately divides transactions of the training transaction data into a fraud class and a non-fraud class.

13. The computerized method of claim 8, wherein generating a fraud detection rule using the trained decision tree model includes:
generating a first initial fraud detection rule and a second initial fraud detection rule using the trained decision tree model;
determining that conditions of the first initial fraud detection rule and conditions of the second initial fraud detection rule are combinable; and
combining the first initial fraud detection rule and the second initial fraud detection rule into the generated fraud detection rule.

14. The computerized method of claim 8, wherein performing a fraud mitigation action in response to identifying the transaction associated with fraud includes at least one of generating a fraud notification associated with the identified transaction, preventing completion of the identified transaction, or implementing fraud prevention measures associated with transactions that are similar to the identified transaction.

15. A computer storage medium has computer-executable instructions that, upon execution by a processor, cause the processor to at least:
obtain training transaction data;
assemble a feature vector using the training transaction data;
generate a decision tree model using the assembled feature vector, the decision tree model including a plurality of nodes;
train the generated decision tree model by providing at least a portion of the training transaction data as input to the decision tree model, obtaining classification output from the decision tree model, evaluating the classification output for accuracy relative to a fraud indicator, and adjusting at least one of weight factors, decision thresholds of nodes of the decision tree model, or tree structure based on the evaluated accuracy;
determine that an impurity ratio of at least one node of the trained decision tree model exceeds an impurity ratio threshold;
based on the determination, eliminate overfitting by pruning one or more child nodes of the at least one node to create a pruned decision tree model;
generate a fraud detection rule using the pruned decision tree model by backtracking a path through the pruned decision tree model starting with a leaf node or pruned node and tracing the path to a root node, and, at each node along the path, generating at least a portion of the fraud detection rule based on a decision threshold of the node;
apply the generated fraud detection rule to input transaction data;
identify a transaction associated with fraud in the input transaction data based on applying the generated fraud detection rule; and
automatically perform a fraud mitigation action in response to identifying the transaction associated with fraud.

16. The computer storage medium of claim 15, wherein the computer-executable instructions, upon execution by the processor, further cause the processor to at least prune the trained decision tree model, the pruning comprising:
identifying a node of the trained decision tree model;
determining that an impurity ratio of the identified node exceeds an impurity ratio threshold;
pruning child nodes of the identified node based on determining that the impurity ratio of the identified node exceeds the impurity ratio threshold; and
designating the identified node as a pruned node of the pruned decision tree model. wherein generating the fraud detection rule comprises backtracking a path through the pruned decision tree model starting with the pruned node.

17. The computer storage medium of claim 16, wherein pruning the trained decision tree model further includes:
determining that the identified node has a valid grandparent node; and
wherein pruning the child nodes of the identified node is further based on determining that the identified node has a valid grandparent node.

18. The computer storage medium of claim 15, wherein assembling the feature vector using the training transaction data includes:
generating data features and the fraud indicator using the obtained training transaction data; and
transforming categorical strings of the generated data features into binary variables; and assembling the feature vector using the generated data features and the binary variables.

19. The computer storage medium of claim 15, wherein generating a fraud detection rule using the trained decision tree model includes:
generating a first initial fraud detection rule and a second initial fraud detection rule using the trained decision tree model;
determining that conditions of the first initial fraud detection rule and conditions of the second initial fraud detection rule are combinable; and
combining the first initial fraud detection rule and the second initial fraud detection rule into the generated fraud detection rule.

20. The computer storage medium of claim 15, wherein performing a fraud mitigation action in response to identifying the transaction associated with fraud includes at least one of generating a fraud notification associated with the identified transaction, preventing completion of the identified transaction, or implementing fraud prevention measures associated with transactions that are similar to the identified transaction.
